(19) United States
(12) Patent Application Publication
(10) Pub. No.: US 2002/0055332 A1
(43) Pub. Date: May 9, 2002

(54) Orthogonal frequency division multiple access two-way satellite system

(76) Inventor: Uzi Ram, Emek Yizrael (IL)

Correspondence Address: BANNER & WITCOFF, 1001 G STREET N W, SUITE 1100, WASHINGTON, DC, 20001, US

(21) Appl. No.: 09/957,464

(22) Filed: Sep. 21, 2001

Related U.S. Application Data
(60) Provisional application No. 60/271,741, filed on Feb. 28, 2001.
(60) Provisional application No. 60/235,546, filed on Sep. 27, 2000.

(51) Int. Cl. H04B 7/185

(52) U.S. Cl. 455/12.1; 455/427

(57) ABSTRACT

An orthogonal frequency division multiple access (OFDMA) scheme is used in a satellite environment to reduce narrowband interference, impulse noise, and signal degradation. The symbol timing of each of the satellite network's multiple terminals may be synchronized, and their frequency separation chosen to obtain near orthogonality condition at the reception, between the wanted demodulated channel, and the transmissions on neighbor channels. The establishment of symbol synchronization between various remote terminals may utilize a central clock which may be recovered from a reference downstream channel from one or more satellites; or where two or more satellites are utilized, the satellites may coordinate to provide a single reference clock to the remote user terminals. The terminals may be provided with additional satellite location information relating to slight movement of the satellites around a nominal location so that the timing of transmissions may be corrected based on a tracking algorithm for detecting slight movement of the satellites. The tracking algorithm may be accomplished with individual timing correction to each of the remote terminal's transmissions. A central hub may enforce global timing by utilizing an individual timing correction loop over the network, and enforce global timing synchronization by sending frequent individual timing correction requests and receiving acknowledgements.

The present application claims priority to provisional patent application Ser. No. 60/271,741 filed Feb. 28, 2001, entitled Orthogonal Frequency Division Multiple Access Two-Way Satellite System, which is a continuation-in-part of U.S. application Ser. No. 60/235,546, filed Sep. 27, 2000, entitled High Capacity Satellite Communication System Optimized for Two-way Broadband Satellite Communications With Remote Very Small Aperture Terminals, herein incorporated by reference.

### FIELD OF THE INVENTION

The present invention relates to the field of satellite communications. More particularly, the present invention relates to satellite communication systems which employ orthogonal frequency division multiplexing, and especially with respect to a return channel in a two-way satellite communication system.

### BACKGROUND OF THE INVENTION

Residential satellite communications have been commercially impractical for the average homeowner. The cost of the space segment, satellite dish, transceiver, and associated knowledge and support have been in general too expensive for the average consumer or small business. Hence there is a need for a lower-cost two-way satellite communication system that is affordable to the average consumer. Accordingly, systems and methods are required to reduce the cost and complexity for the average user.

Orthogonal frequency division multiple access (OFDMA) systems have been proposed for terrestrial broadcast systems such as HDTV, cable systems, and cellular telephone systems, particularly with respect to audio/visual transmissions such as digital audio broadcast and digital video broadcast. OFDMA has also been proposed for use with wireless LAN standards such as 802.11a. In its simplest form, OFDMA schemes employ an inverse discrete Fourier Transform, usually implemented as a inverse Fast Fourier Transform (IFFT). At the receiver end, the signal is usually recovered using a standard fast Fourier Transform (FFT). Using this technique, the frequency spectrum of the subcarriers overlap in a manner where they maintain a orthogonal relationship. At certain points in the frequency spectrum the signal level for all other signals are zero while the signal level for one of the subcarriers may be determined.

Heretofore, OFDMA has not been successfully employed in satellite broadcast, particular on the inbound channel, because the receiver and transmitter must be perfectly synchronized in both the modulation frequency and time domain.

### SUMMARY OF THE INVENTION

In order to overcome the disadvantages of conventional systems, there are a number of objects and associated aspects of the present invention, which make the use of OFDMA practical over two-way satellite systems. Accordingly, it has been found that orthogonal frequency division multiple access (OFDMA) scheme in a satellite environment reduces narrowband interference, impulse noise, and other signal degradation problems typically found in satellite communications, particularly on the inbound channel. Further, in conventional satellite based frequency division multiple access schemes, a different demodulator is required to accommodate each simultaneous user. By contrast, OFDMA may be implemented using only a single demodulator for a plurality or all of the simultaneous users. After demodulation, the signal may be processed using, for example, a N-point discrete Fourier transform (DFT) for N simultaneous users. The OFDMA scheme may be employed in conjunction with a demand assignment, TDMA, or random access scheme. The OFDMA scheme may also be employed in conjunction with two-dimensional ALOHA based schemes where data slots are based on both time and frequency. These systems may be viewed as OFDMA based ALOHA or OFDMA-ALOHA. Thus, only a single demodulator is required at the inbound to process all incoming OFDMA signals. This scheme has substantial advantages when utilized in a satellite system.

Aspects of the present invention include using an orthogonal frequency division multiple access scheme in two-way VSAT applications to a plurality of disperse users. In order to implement such a system, aspects of the invention may include implementing one or more of the following:

1. Coordination between multiple terminals in a satellite network such that the symbol timing of each of the satellite network's multiple terminals may be synchronized, and their frequency separation chosen to obtain near orthogonality condition at the reception, between the wanted demodulated channel, and the transmissions on neighbor channels.

2. The establishment of symbol synchronization between various remote terminals may utilize a central clock which may be recovered from a reference downstream channel from one or more satellites; in alternate embodiments where two or more satellites are utilized, the satellites may coordinate to provide a single reference clock to the remote user terminals.

3. The user terminals may be provided with additional “satellite location” information which relates slight movement of the satellites around a nominal location. This allows for the correction of the timing of transmissions based on a tracking algorithm which may be utilized to detect slight movement of the satellites. The tracking algorithm may be accomplished with individual timing correction to each of the remote terminal's transmissions. To minimize the amount of traffic that is dedicated for the tracking, the downstream communication path may provide data regarding the estimated location of the satellite at that time. Information about the “satellite location” may be partial—for instance, it may be only the distance of the Satellite from the Hub location (this is partial information because it does not account for the fact that the location is a function of three independent axes) or it may be an absolute location.

4. The central hub may enforce global timing by utilizing an individual timing correction loop over the network. The hub may enforce global timing synchronization by sending frequent individual timing correction requests and receiving acknowledgements. In this manner, each individual terminal may be polled to determine any necessary timing corrections. Thus, the hub may ensure that no individual remote terminal is out of synchronization.

In further aspects of the invention, the system may utilize a constant envelope modulation such as unfiltered BPSK and QPSK. These modulations can be transmitted via a saturated transmitter, which may be more cost effective.

The use of the above improvements allows for multiple inbound carriers in an orthogonal manner (OFDMA) and provides many advantages. For example, it reduces significantly the required multiple-user upstream bandwidth, compared to other modulation techniques with comparable communication performance. This bandwidth savings is especially significant when the system becomes saturated with respect to transmitters at the remote terminals.

These and other features of the invention will be apparent upon consideration of the following detailed description of preferred embodiments. Although the invention has been defined using the appended claims, the invention may include one or more aspects of the embodiments described herein including the elements and steps described in any combination or subcombination. For example, it is intended that each of the above aspects of the invention may be used individually and/or in combination with one or more other aspects of the invention defined above and/or in connection with the detailed description below. Accordingly, there are any number of alternative combinations for defining the invention, which incorporate one or more elements from the specification, including the description, claims, aspects of the invention, and/or drawings, in various combinations or subcombinations. Accordingly, it will be apparent to those skilled in satellite communication art in view of the present specification, that alternate combinations and subcombinations of one or more aspects of the present invention, either alone or in combination with one or more elements and/or steps defined herein, may constitute alternate aspects of the invention. It is intended that the written description of the invention contained herein cover all such modifications and alterations.

### BRIEF DESCRIPTION OF THE DRAWINGS

The foregoing summary of the invention, as well as the following detailed description of preferred embodiments, is better understood when read in conjunction with the accompanying drawings, which are included by the way of example, and not by way of limitation with regard to the claimed invention in the accompanying figure in which like reference numerals indicate similar elements.

FIG. 1 shows an exemplary block diagram of a satellite system which may be utilized with the present invention.

FIG. 2. shows an exemplary block diagram of a transmitter portion of the remote stations for use in aspects of the present invention.

FIG. 3 shows an exemplary block diagram of a receiver portion of the Hub stations which may be utilized in aspects of the present invention.

FIG. 4 shows an exemplary block diagram of a typical remote station.

FIG. 5 shows an exemplary block diagram of a typical hub station.

FIG. 6 shows a exemplary flow chart of the operation of the satellite system shown in FIG. 1.

### DETAILED DESCRIPTION OF THE INVENTION

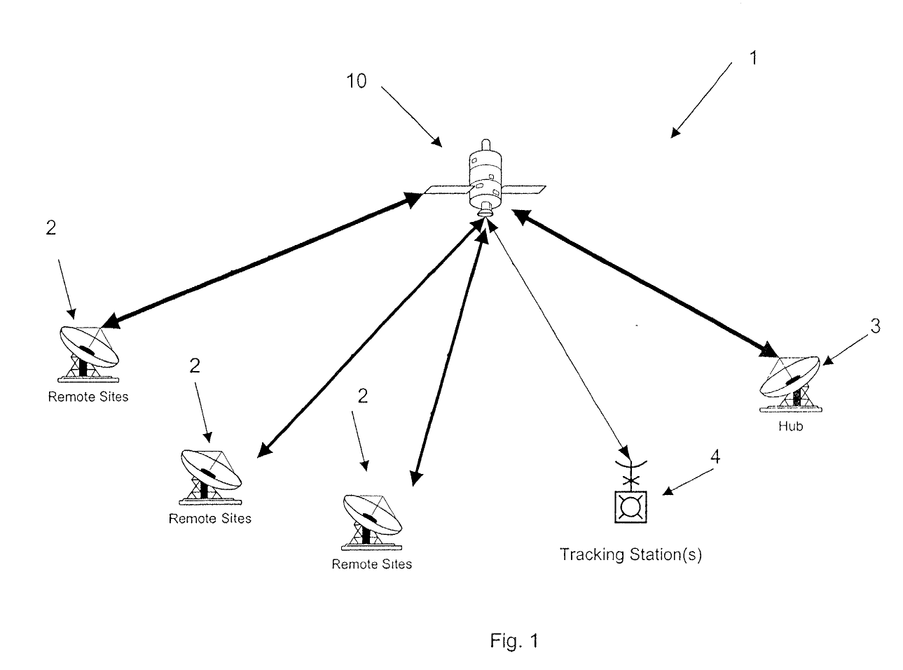

Referring to FIG. 1, embodiments of the present invention may include a two-way satellite system 1 having a plurality of remote sites 2 communicating through a satellite 10 to a hub 3. Communication on the inbound path going from the remote sites 2 to the hub 3 can be difficult to coordinate. For example, where multiple devices are attempting to transmit information to the hub 3 at the same time, a multiple access scheme is desirable to allow communication. In accordance with aspects of the invention, orthogonal frequency division multiple access (OFDMA) schemes may be utilized on the inbound channel of a satellite system. The use of the OFDMA scheme reduces narrowband interference, impulse noise, and other signal degradation problems typically found in satellite communications, particularly on the inbound channel.

However, heretofore it has not been possible to use OFDMA on the inbound channel of a satellite due to the difficulty of maintaining the exacting timing requirements necessary for an OFDMA scheme to operate. It has been found that a major source of these timing imperfections are caused by minor variations in the position of a satellite around a “normal” position. For example, even a satellite in a geosynchronous orbit experiences slight movement of the satellite around a normal position. The exact location of the satellite may be determined using any suitable technique such as one, two, three or more tracking stations 4. The movement of the satellite varies the timing relationship between all of the various remote sites in the system. Further, with many, many, remote sites located across a vast area, it has heretofore been impossible to keep all of the stations synchronized. Accordingly, aspects of the present invention solve this problem.

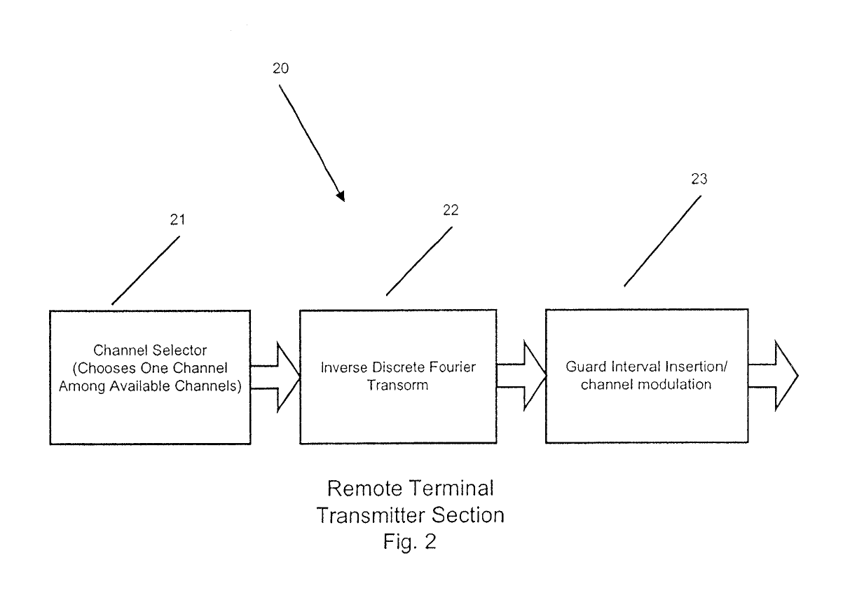

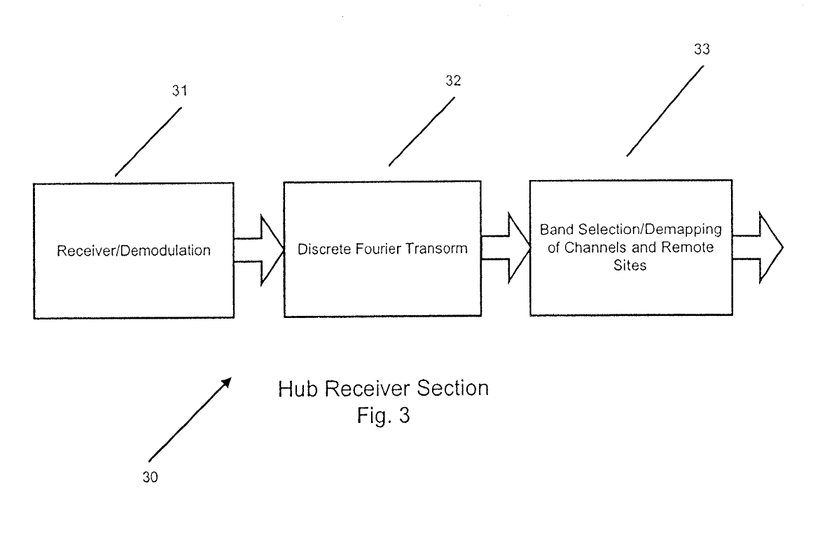

Referring to FIG. 2, the remote sites 2 typically include a remote terminal transmitter section 20. The transmitter section 20 may include, for example, a channel selector 21 for selecting one of a plurality of channels, an inverse discrete Fourier Transform for performing the OFDMA transformations, and a guard interval Inserter and channel modulator 23. Referring to FIG. 3, the Hub 3 may include a Hub receiver section 30 for de-multiplexing the incoming channels. For example, in the embodiment shown in FIG. 3, the Hub receiver section 30 includes a RF receiver/demodulator 31, a discrete Fourier Transform 32, and a band selection and demapping section 33. Together, the remote terminal transmitter section 20 at the remote sites and the Hub receiver section 30 at the Hub site perform the OFDMA process.

Selection of the channels in the OFDMA scheme may be variously configured. For example, the channel selection may be based on a fixed access scheme. However, the use of a fixed access scheme often wastes substantial bandwidth particularly where multiple terminals are used for Internet access which may be employed infrequently. For some environments, the bandwidth problem may be solved using a demand access scheme. However, a demand access scheme may be undesirable in many environments due to the requirement for a signaling channel and the addition of undesirable latency. This is particularly problematic for Internet based remote terminal access where a user does not desire to wait for a channel to be set-up each time another web page is accessed. Further, the setup time is substantially increased due to the long round trip delay time over a satellite.

In order to solve these problems, it has been found that a contention scheme used in conjunction with OFDMA provides substantially improved performance. In particular, it has been found that OFDMA works particularly well with either a one dimensional or a two dimensional ALOHA scheme. For example, at any one time, each remote terminal may compete to access all channels of the OFDMA scheme or only selected contention channels. Where a collision occurs, the remote site may try again at a later time and/or on a different channel.

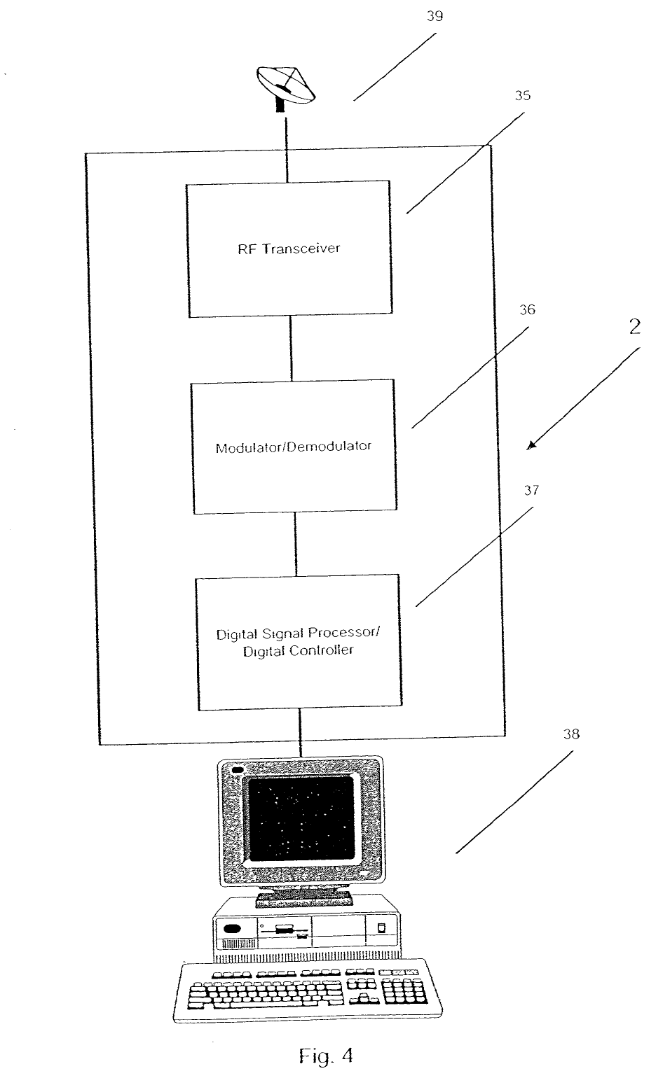

Referring to FIG. 4, an exemplary embodiment of one of the remote sites 2 is shown. For example, the remote site 2 may include an antenna 39, a satellite transceiver unit having a RF transceiver 35, a modulator/demodulator 36, and a digital signal processor/digital controller 37, and one or more remote work station(s) 38. The digital signal processor/digital controller 37 may include a single controller, or a plurality of controllers and/or discrete logic. For example, one or more control processors may be coupled to one or more signal processors and/or logic implementations of inverse discrete Fourier transforms. Further, the satellite transceiver unit may be a separate unit disposed external to the remote workstation(s) 38 and/or incorporated into a receiver card within the remote workstation(s) 38. The RF transceiver is preferably configured to transmit all of the available OFDMA frequency signals. It may also be configured to receive either OFDMA signals or conventional TDMA signals. The modulator 36 may receive any suitable modulation scheme. For example, the modulator/demodulator may utilize unfiltered BPSK and/or QPSK modulation schemes since these modulation schemes may be transmitted via a saturated transmitter.

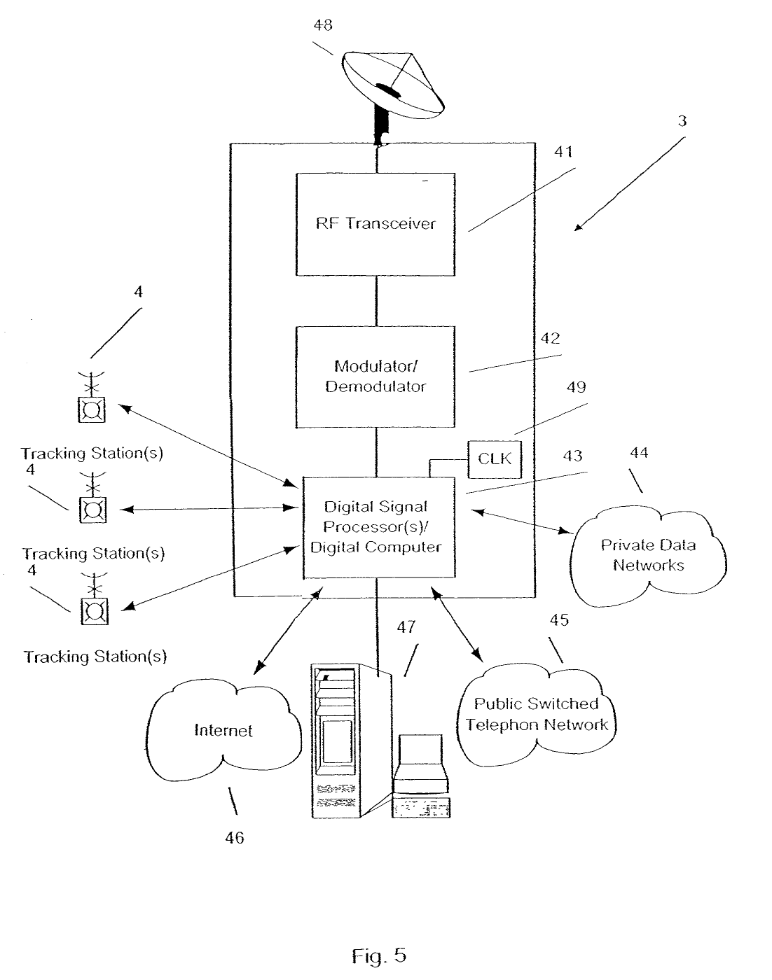

Referring to FIG. 5, the Hub 3 may be variously configured. In exemplary embodiments, the Hub 3 includes an antenna 48, a RF transceiver 41, one or more modulator/demodulator(s) 42, a synchronizing clock 49, and one or more digital signal processors(s)/digital computers(s) 43. The digital signal processors(s)/digital computers(s) 43 may be coupled to various devices such as private data networks 44, public switched telephone networks 45, network management and control computers 47, various public networks such as the Internet, and/or one or more tracking stations 4.

In frequency division multiple access schemes, typically a different demodulator is required to accommodate each simultaneous user. By contrast, OFDMA may be implemented using only a single demodulator for a plurality or all of the simultaneous users. After demodulation, the signal may be processed using, for example, an N-point discrete Fourier transform (DFT) for N simultaneous users. Where the incoming signal is generated using a random access scheme such as one or two-dimensional ALOHA, the N-point discrete Fourier transform (DFT) is performed for all data slots and an analysis is undertaken to determine collisions. In any event, the Hub 3 need only have a single demodulator to process all incoming OFDMA signals. These systems may be viewed as OFDMA based ALOHA or OFDMA-ALOHA. This scheme has substantial advantages when utilized in a satellite system.

In yet other embodiments, the remote terminals may be grouped into bands such that certain ones share a first bandwidth F1 and others share a second bandwidth F2. In these configurations, two demodulators may be utilized. The demodulators may utilize the same digital signal processor or may use two different digital signal processors acting in parallel. In this manner, the system is fully scalable to accommodate any number of users.

The timing and coordination of the OFDMA scheme in accordance with the present invention may be explained with reference to FIG. 5. In exemplary embodiments, it is often desirable to coordinate the symbol timing between multiple terminals in the satellite network such that the symbol timing of each of the remote sites 2 is synchronized. Where the synchronization is precise, it is possible to use OFDMA over a satellite and still obtain near orthogonality condition at the reception, between the wanted demodulated channel, and the transmissions on neighboring channels. These orthogonal signals may be maintained across all bands or within any one band.

In some embodiments, symbol synchronization may be achieved by utilizing a central clock such as synchronizing clock 49. The clock signal may be transmitted by the hub 3 and recovered from the downstream channel by each of the remote terminals. In alternate embodiments, the synchronizing clock 49 may be output directly from the satellite to each of the remote terminals 2 and/or Hub 3.

In exemplary embodiments, the synchronizing signal may be accompanied by satellite location information. The satellite location information may comprise an absolute location of the satellite and/or a relative position of the satellite with respect to each of the remote terminals. Alternatively, the satellite location information may include a “normal” position and then subsequent indications of slight movement around the “normal” position. The exact location of the satellite may be determined by tracking algorithms on-board the satellite itself using triangulation and/or using various ground based tracking station(s) 4 (shown in FIGS. 1 and 5).

The user terminals may be provided with additional “satellite location” information which relates slight movement of the satellites around a nominal location. The additional satellite location information may come directly from the satellite, from the Hub 3, and/or from one or more tracking station(s) 4. The transmission of additional satellite location information need only determine the movement from the nominal location, and need not transmit every axis. This additional information allows for the correction of the timing of transmissions and may be based on a tracking algorithm. The tracking algorithm may be located in the Hub 3, the satellite 10, in one or more of the tracking stations 4, and/or in any combination of the tracking station(s) 4, Hub 3, satellite 10, and/or remote sites 2.

For example, the tracking algorithm may be accomplished by individual timing correction to the remote sites. This may be based on the location of the terminal relative to the current position of the satellite or based on a feedback timing loop. Where individual timing corrections are based on the relative position of the satellite at any given time to each of the remote sites, it may be desirable to have each terminal calculate a portion of the timing correction. This may be based on current information only and/or based on projections obtained from past location information in conjunction with current location information. To minimize the amount of traffic that is dedicated for the tracking, the downstream communication path may provide data regarding the estimated location of the satellite at that time. The information concerning the location of the satellite need not be absolute. For example, information about the “satellite location” may be partial, such as only the distance of the satellite 10 from the Hub location. This single axis information only provides a portion of the overall position information without regard to each of the three independent axes. Additionally, the information may include the distance of the satellite 10 from the Hub 3 and/or the distance of the satellite to each of the remote terminals 2. The later location information may be desirable to transmit where this information is not calculated by each of the remote terminals.

In still further embodiments, the Hub 3 may enforce global timing over all or a part of the satellite network 1 using a timing feedback loop. The timing feedback loop may be implemented on a global basis or by using individual timing corrections for each remote site 2. Where individual timing synchronizations are utilized, it may be desirable for the Hub 3 to poll individual sites on a periodic basis by sending individual timing correction requests to each of the remote sites 2. For example, it may be desirable to send a timing correction request once every 500 ms, 1 s, 5 s, 10 s, or every minute. In many embodiments, where a timing correction request is sent, the remote terminals respond using acknowledgements. The acknowledgement may be processed using an algorithm to determine the degree of orthogonality with respect to other signals and thus determine whether the signal timing of the individual remote site 2 must be advanced or retarded. In this manner, each individual terminal may be polled such that timing correction may be enforced by the central hub 3 to ensure that no individual terminal 2 is out of synchronization. The polling response method may be utilized in addition to the location method and/or as an alternative to the location information method. Where both methods are utilized, the frequency of the individual timing correction requests may be reduced and the overall accuracy and reliability of the system may be increased.

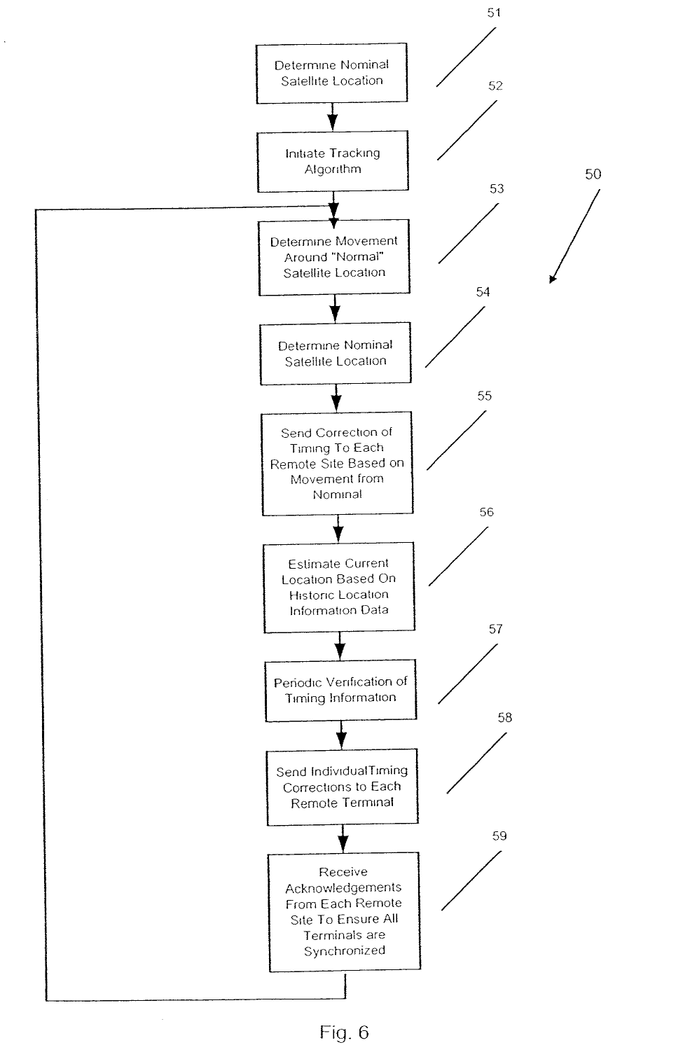

In one exemplary embodiment, the timing corrections may be accomplished as shown in FIG. 6. In step 51, a determination may be made of the nominal satellite location. This may be accomplished using any of the techniques discussed above. Once an initial nominal satellite location is determined, a tracking algorithm may be initiated in step 52. The tracking algorithm may be implemented in any one or more of the Hub 3, the tracking station(s) 4, the satellite 10 and/or the remote sites 2. In step 53, a determination is made as to the movement of the satellite. This may be movement from the normal location or absolute location at a different time then the initial determination of the normal location. In either case, the change in position of the satellite is determined and new location information is acquired in step 54. The new location information may be acquired once every 10 ms, 50 ms, 100 ms, 250 ms, 500 ms, every 1 s, every 5 s, every 10 s, or every minute. The frequency of acquiring new location information is dependent on the amount and speed of the variations of the satellite location. The frequency of the new location information may be adjustable. For example, where a satellite is utilized which has a large and/or relative rapid variations, the new location information may be acquired more frequently. Where the satellite has relatively minor variations that occur at a low frequency, the new location information may be acquired less frequently such as every few seconds.

In step 55, the timing corrections may be sent to each remote site 2 based on the movement of the satellite from the nominal location. The corrections of timing may specify whether a particular site is to advance or retard its timing. Alternatively, the corrections of timing may be location information which allows the individual remote sites 2 to calculate their own corrections to timing based on the physical location of the remote site.

In step 56, the timing algorithm may extrapolate the current location of the satellite based on historical data. For example, where the satellite is known to oscillate about a nominal position, it is possible to extrapolate the expected location of the satellite based on historical data. The extrapolation may occur between the time that the actual physical measurements are made. For example, a physical measurement of the exact location of a satellite may be limited in its accuracy. Thus, the physical measurement may occur once every 30 seconds or once every minute. However, based on historical data, the position of the satellite at any time in the intervening period may be determined by extrapolation. Thus, it is possible to calculate the estimated current position of the satellite even though a measurement has not occurred. This allows for very precise timing estimates between physical measurements, substantially increasing the accuracy and reliability of the OFDMA system over the satellite.

In step 57, a timing feedback loop verification may be performed. Where a timing feedback loop is utilized, it may be desirable to periodically verify that the timing of an individual remote site is correctly synchronized with all of the other remote sites. By polling the individual sites, it is possible to verify that the timing is correct and to make minor adjustments to individual remote sites 2 by advancing or retarding the site's timing based on the feedback request/acknowledgement loop determination. The individual timing adjustments may be sent, for example, in step 58. The acknowledgements may be received, for example, in step 59. In some embodiments, the feedback request/acknowledgements may be utilized as a fine correction where the location information may be utilized as a coarse correction to the timing. Although systems may use either of the location information or the synchronization feedback loop, it is often desirable to employ both techniques in the same system to substantially improve accuracy and reliability. For example, where one remote site 2 has a delay in the transmitter, the feedback loop will detect this variation and adjust the timing accordingly. Meanwhile, the timing changes caused by the changes in the location of the satellite will continue to be accounted for using the location information.

The use of the above improvements allows for multiple inbound carriers in an orthogonal manner (OFDMA) and provides many advantages. For example, it reduces significantly the required multiple-user upstream bandwidth, compared to other modulation techniques with comparable communication performance. This bandwidth saving is especially significant when the system becomes saturated with respect to transmitters at the remote terminals.

These and other features of the invention will be apparent upon consideration of the following detailed description of preferred embodiments. Although the invention has been defined using the appended claims, the invention may include one or more aspects of the embodiments described herein including the elements and steps described in any combination or subcombination. While steps 51 to 59 are indicated in a particular order, this order need not be maintained for all systems. For example, in FIG. 6 the nominal satellite location is determined first. This need not necessarily be the first step or any step, although it is normally desirable to establish a baseline position for the satellite. Similarly, the feedback/acknowledgement step may be performed prior to any determination as to the movement of the satellite from the nominal location. Additionally, the steps in FIG. 6 may have one or more sub-loops. For example, the determination of the new nominal location may occur many times before a new feedback/acknowledgement cycle is completed. Similarly, the feedback/acknowledgement cycle may occur many times before a new nominal location is determined.

It is intended that each of the above aspects of the invention may be used individually and/or combination with one or more other aspects of the invention defined above and/or in connection with the detailed description below. Accordingly, there are any number of alternative combinations for defining the invention, which incorporate one or more elements from the specification, including the description, claims, aspects of the invention, and/or drawings, in various combinations or subcombinations. Accordingly, it will be apparent to those skilled in satellite communication art in view of the present specification, that alternate combinations and subcombinations of one or more aspects of the present invention, either alone or in combination with one or more elements and/or steps defined herein, may constitute alternate aspects of the invention. It is intended that the written description of the invention contained herein cover all such modifications and alterations.

We claim:

1. A method of operating a satellite communication system comprising:
coordinating multiple terminals in a satellite network such that the symbol timing of each of the multiple terminals in the satellite network are synchronized;
configuring a frequency separation for each of the multiple terminals to obtain near orthogonality condition at the reception between a desired demodulated channel and transmissions on neighboring channels.

2. In an orthogonal frequency division multiplexed satellite system, a method comprising establishing symbol synchronization between multiple remote terminals utilizing a central clock recovered from a reference downstream channel output from a satellite.

3. A method comprising providing satellite location information which relates slight movement of a satellites to a plurality of remote terminals employing orthogonal frequency division multiple access.

4. A method of claim 3, wherein said satellite location information is utilized by said plurality of remote terminals to correct timing of transmissions with individual timing correction to each of said remote terminals.

5. A method of claim 3, wherein said satellite location information relates to a single axis of said satellite.

6. A method of claim 5, wherein the part of said satellite location information is the distance of said satellite from a hub.

7. A method of claim 3, wherein said satellite location information is an absolute location.

8. An apparatus comprising a hub including one or more antennas, RF transceivers, modulators, demodulators, clocks, and digital signal processors, said hub being configured to receive signals using an OFDMA scheme and to transmit timing information to a plurality of remote terminals based on satellite location information.

9. An apparatus comprising a hub including one or more antennas, RF transceivers, modulators, demodulators, clocks, and digital signal processors, the hub being configured to receive signals using an OFDMA scheme and to transmit timing information to a plurality of remote terminals based on a timing synchronization feedback/acknowledgement loop.

10. An apparatus comprising a hub including one or more antennas, RF transceivers, modulators, demodulators, clocks, and digital signal processors, the hub being configured to receive signals using an OFDMA scheme and to transmit information related to synchronization of a plurality of remote terminals, said information relating to both synchronization feedback/acknowledgement loops and satellite location information.

11. In an orthogonal frequency division multiplexed satellite system utilizing multiple satellites, a method comprising establishing symbol synchronization between various remote terminals by utilizing a single reference clock coordinated by said multiple satellites to said remote terminals.

12. A method of operating a satellite communication system comprising:
providing multiple terminals in a satellite network with satellite location information relating to movement of satellites around a nominal locations so that timing of transmissions may be corrected based on a tracking algorithm for detecting movement of said satellites.

13. A method as recited in claim 12, wherein said tracking algorithm is accomplished with individual timing correction of transmissions to each of said multiple terminals.

14. In an orthogonal frequency division multiplexed satellite system, a method comprising establishing symbol synchronization between multiple remote terminals utilizing a central clock utilizing an individual timing correction loop.

15. A method as recited in claim 14, wherein a hub may enforces global timing synchronization by sending individual timing correction requests and receiving acknowledgements to each individual terminal to determine any necessary timing corrections.
